(19) United States
(12) Patent Application Publication
(10) Pub. No.: US 2020/0101877 A1
(43) Pub. Date: Apr. 2, 2020

(54) Child safety seat with remote control reclining feature

(71) Applicant: Glenda Bonds, Seminary, MS (US)

(72) Inventor: Glenda Bonds, Seminary, MS (US)

(21) Appl. No.: 16/147,745

(22) Filed: Sep. 29, 2018

(51) Int. Cl. B60N 2/28; A47C 31/00; B60N 2/90; B60N 2/00; B60N 2/60; G01G 19/414; G01G 19/44

(52) U.S. Cl. CPC B60N 2/2878; B60N 2/2845; A47C 31/008; B60N 2/90; B60N 2002/981; B60N 2/60; B60N 2/2881; G01G 19/4142; G01G 19/44; B60N 2/002

(57) ABSTRACT

The invention is directed to a child safety seat with remote control reclining feature. The safety seat provides a battery-powered electric servomotor which drives an internal gear system that gently and quietly moves the safety seat from an upright position to a reclining position. The reclining feature may be operated by a remote control, which is provided, or by a mobile application which may be downloaded and installed on the user's smartphone, tablet, or other mobile electronic device. The safety seat further provides a pressure switch which detects the presence of a child, and provides an audible alert if the child remains in the safety seat more than 60 seconds after engine of the vehicle stops running.

This application relates back to, and claims the priority of Provisional Patent Application No. 62/611,278 filed on Dec. 28, 2017.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to child care accessories, and in particular to a child safety seat with remote control reclining feature. Millions of parents have noticed and welcomed the tendency of infants and young children to fall asleep in a moving vehicle. Unfortunately, they tend to fall asleep in an upright position. This denies them truly restful sleep, and leaves them very vulnerable to being accidentally jostled and awakened. Most child safety seats do not offer a reclining feature, and the ones that do offer it require the parent to stop the vehicle and engage in actions which risk awakening the child, thus defeating the advantage.

A search of the prior art reveals various devices which have been developed to address this set of problems, or related problems. None are closely related to the present invention, but several include features which resemble those of the present invention. Each has proven to be less than satisfactory for the present purpose in its own way.

Pivotable reclining child safety car seat, U.S. Pat. No. 6,739,661 (priority Jul. 15, 2002), provides a child safety seat which pivots between a sitting and reclining position on a base secured by a vehicle safety belt. A pair of pivot arms extending from each side of the safety seat slide in a pair of grooves in each side of the base. The primary pivot arm moves in an essentially horizontal groove to maintain a low center of gravity. A secondary pivot arm stabilizes the safety seat and helps to maintain the safety seat back in close proximity with the vehicle seat back. A high pivot arm near the top of each side of the seat may be positioned in a mating opening or a slotted opening in each side of the base. A motor and reversible drive assembly, which may be remotely controlled can be used to move the safety seat.

Motorized remote controlled reclining child car seat, U.S. Pat. No. 6,739,659 (priority Feb. 11, 2002), provides a motor and sprocket drive which move a child safety seat between a sitting and reclining position on a base secured by a vehicle safety belt. A drive shaft and gear system, drive belt with pulley system, double action winch and cord system or other drive system positioned within an enclosed base move the sprocket reversibly. A remote control operable by the driver of the vehicle controls the seat motor. A pair of sprockets housed in the base interacts horizontally with a mating pair of arched tracking grooves in the seat to move the seat with no weight bearing on the sprockets. The electric motor may be battery powered or plugged into the cigarette lighter of the vehicle. The sprocket or a solenoid lock the seat in place. (See also U.S. Pat. No. 6,739,660.)

Remote motor controlled adjustable infant car seat device, U.S. Patent Appl. No. 2003/0151281A1 (priority Feb. 8, 2002), provides an infant child restraint device which is designed and configured to comfortably and safely restrain an infant while providing an device that will enable the changing of position of the seat from an upright to a recline or from a recline position to an upright position. This alteration of positions is accomplished via a movement adjustment apparatus. The present invention further comprises a frame member that will receive the seat shell. The seat frame remains stationary while the seat shell moves about the frame. Secured to the seat shell and the seat frame is the movement adjustment apparatus. This movement adjustment apparatus will push or pull the seat to innately provide for the shell to be in an upright or reclined position.

Pivotable child seat for use in a vehicle, U.S. Pat. No. 7,073,859 (priority Aug. 19, 2004), provides a child safety seat which includes a seat body that is attached to a base that is held in place by the vehicle seat belt. The base provides for movement of the seat body around at least one axis. A turntable allows the seat body to be rotated from a safe-riding position to face the car door to facilitate positioning the child in the seat or to make it easier to grasp and maneuver a separable child carrier with the child in it. Inadvertent rotation of the turntable is prevented by a locking mechanism that remains engaged until released by the parent or caregiver. In one embodiment, a second axis of movement allows the seat body to be reclined so that the child's head is supported when he or she falls asleep. The reclining adjustment is a motorized motion which can be remotely controlled by the parent or caregiver sitting in the front of the vehicle via wires connected to a remote control.

Remote controlled baby seat, U.S. Patent Appl. No. 2006/0181124A1 (priority Feb. 2, 2005), provides a baby car seat for mounting in a vehicle and securing a baby or infant therein, the baby car seat having a base member and a shell-like seat member secured thereto, the shell-like seat member securing the baby therein, the base member and shell-like seat member being in communication by means of a motor means and gearing mechanism, the base member having a receptor mounted therein, communicatable from the front seat of the vehicle, the parent operator of the vehicle having a remote control unit which will communicate with the receptor so as to cause the motor and gearing mechanism to move the shell portion of the baby seat from an upright position to a reclined position or vice versa, depending upon the alertness of the baby or infant secured within the baby car seat.

Reclining baby car carrier, U.S. Patent Appl. No. 2012/0280540A1 (priority May 5, 2011), provides a baby car carrier dimensioned to hold a small child safely in a motor vehicle. The base of the device sets atop a car seat and is secured by means of a seatbelt. A frame is rotatably affixed to the top of the base. The top of the frame is concave and slidably supports the convex bottom of a cradle assembly. The cradle assembly can recline relative to the frame by motorized means. A plurality of padded nesting inserts are provided on top of the cradle assembly allowing for growing children by successive removal of the nesting inserts. Variations further include cup holders, trays, a retractable shade, a headrest, an inflatable pillow, vibration, heat, and an arm to dangle a toy.

A device that enables parents to gently recline the child safety seat without stopping the vehicle would be very useful, and would be well received. A child safety seat with remote control reclining feature, enabling a user to remotely and gently recline the child safety seat, would resolve this problem.

### SUMMARY OF THE INVENTION

Accordingly, the invention is directed to a child safety seat with remote control reclining feature. The safety seat provides a battery-powered electric servomotor which drives an internal gear system that gently and quietly moves the safety seat from an upright position to a reclining position. The reclining feature may be operated by a remote control, which is provided, or by a mobile application which may be downloaded and installed on the user's smartphone, tablet, or other mobile electronic device. The safety seat further provides a pressure switch which detects the presence of a child, and provides an audible alert if the child remains in the safety seat more than 60 seconds after engine of the vehicle stops running.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate one embodiment of the invention and, together with the description, serve to explain the principles of the invention.

FIG. 1 is a rear view of the first exemplary embodiment in the rear facing upright position, displaying the safety seat 10, the cradle 11, the release button 12, and the handle 13.

FIG. 2 is a side view of the first exemplary embodiment in the rear facing upright position, displaying the safety seat 10, the cradle 11, the release button 12, and the handle 13.

FIG. 3 is a side view of the first exemplary embodiment in the rear facing reclining position, displaying the safety seat 10, the cradle 11, the release button 12, and the handle 13.

FIG. 4 is a top perspective view of the first exemplary embodiment in the rear facing upright position, displaying the safety seat 10, the cradle 11, the release button 12, and the handle 13.

FIG. 5 is a top perspective view of the first exemplary embodiment in the rear facing reclining position, displaying the safety seat 10, the cradle 11, the release button 12, and the handle 13.

FIG. 6 is a rear view of the first exemplary embodiment in the front facing reclining position, displaying the safety seat 10, the cradle 11, the release button 12, and the handle 13.

FIG. 7 is a side view of the first exemplary embodiment in the front facing reclining position, displaying the safety seat 10, the cradle 11, the release button 12, and the handle 13.

FIG. 8 is a side view of the first exemplary embodiment in the front facing reclining position, displaying the safety seat 10, the cradle 11, the release button 12, and the handle 13.

FIG. 9 is a top perspective view of the first exemplary embodiment in the front facing reclining position, displaying the safety seat 10, the cradle 11, the release button 12, and the handle 13.

FIG. 10 is a top perspective view of the first exemplary embodiment in the front facing reclining position, displaying the safety seat 10, the cradle 11, the release button 12, and the handle 13.

FIG. 11 shows an illustrative diagram of various mobile electronic devices communicating with the child safety seat.

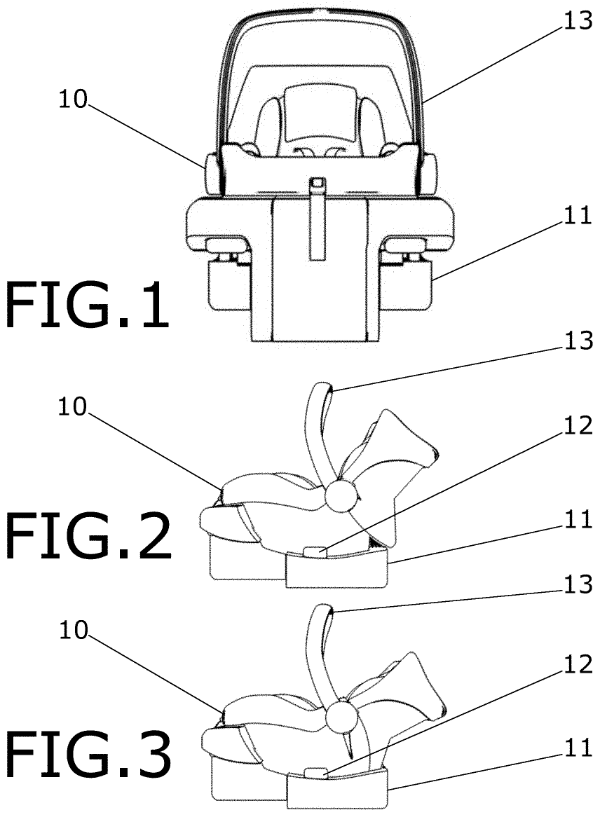

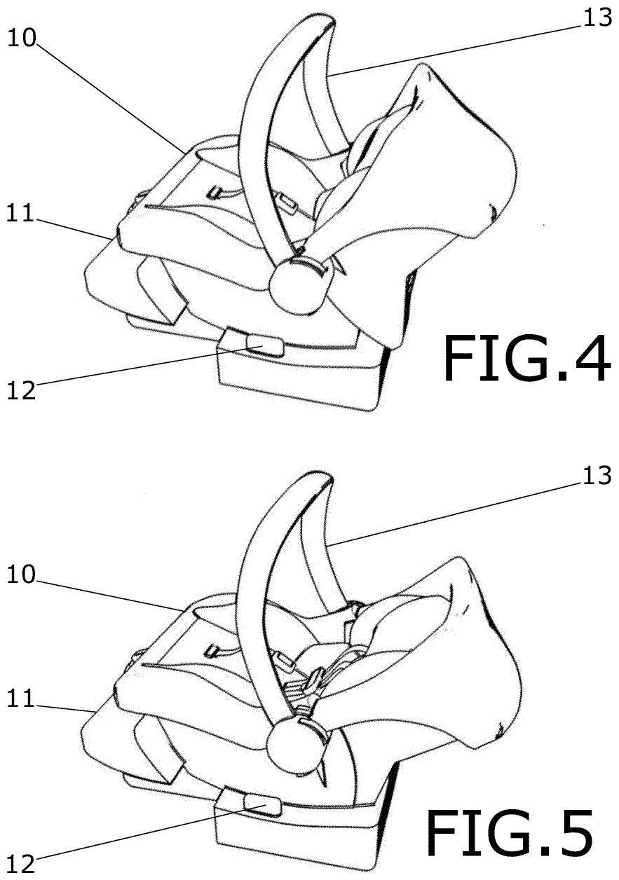

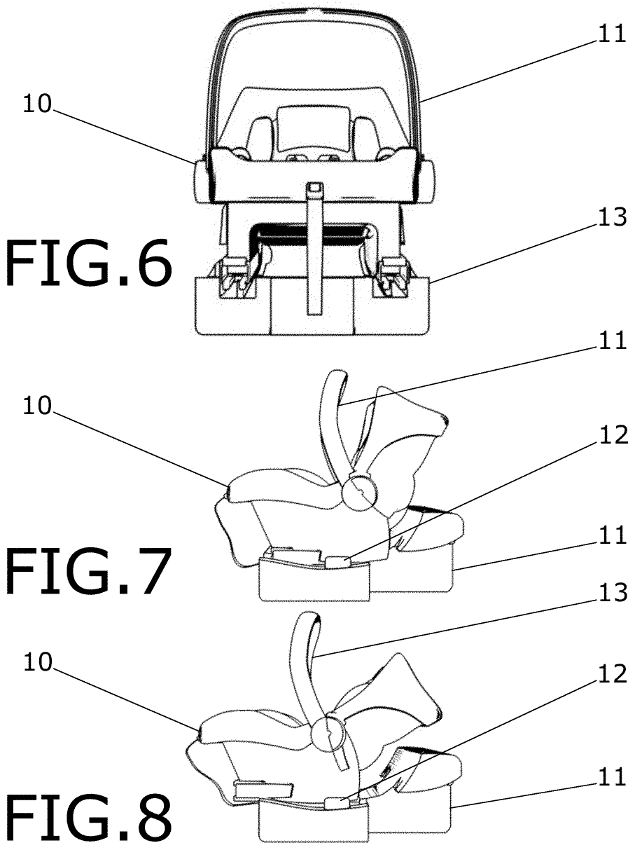

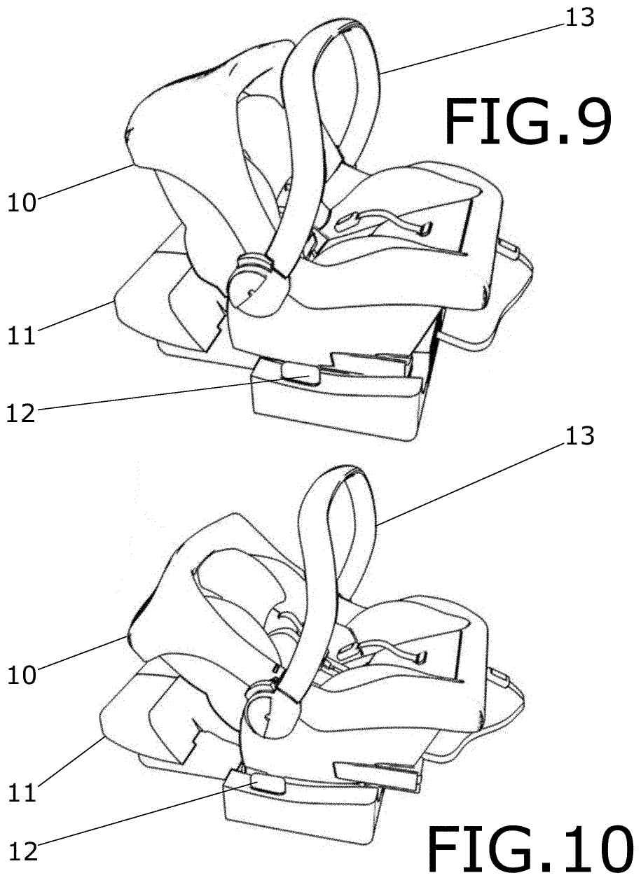

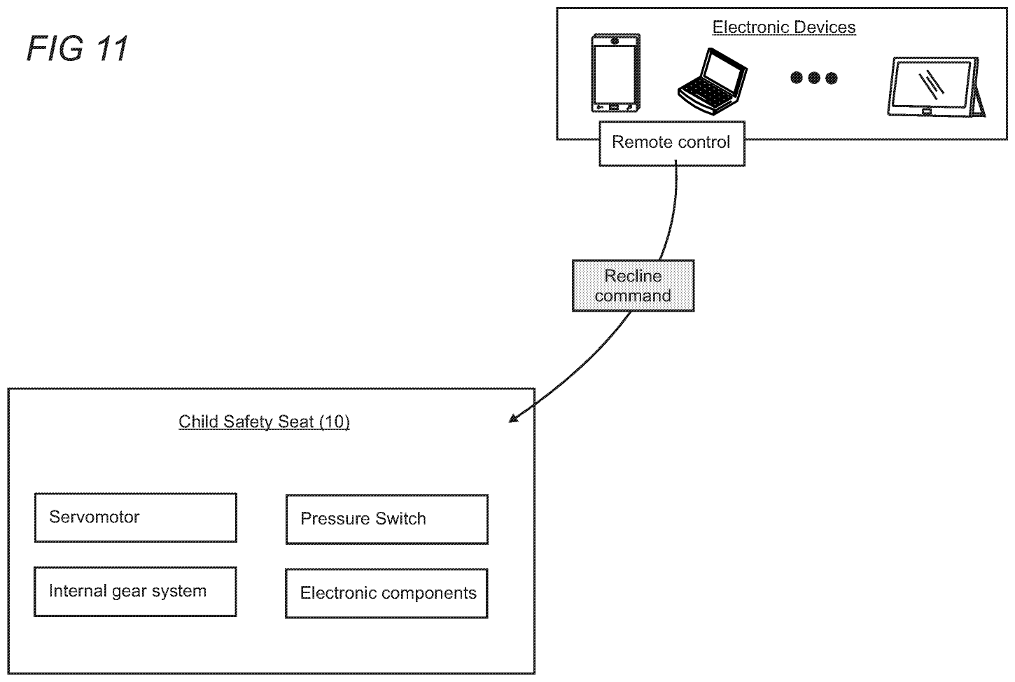

### DETAILED DESCRIPTION OF THE INVENTION

Referring now to the invention in more detail, the invention is a child safety seat 10 with remote control reclining feature.

The first exemplary embodiment is comprised of a child safety seat 10 which provides a battery-powered electric servomotor, driving an internal gear system that gently and quietly moves the safety seat 10 from an upright position to a reclining position. The reclining feature may be operated by a remote control, which is provided, or by a mobile application which may be downloaded and installed on the user's smartphone, tablet, or other mobile electronic device.

The safety seat 10 further provides a pressure switch which detects the presence of a child, and provides an audible alert if the child remains in the safety seat more than 60 seconds after engine of the vehicle stops running. The pressure switch is activated by a predetermined amount of weight, such as 4.4 pounds (2 kilograms).

The safety seat 10 may be secured in a forward or rear facing position within a cradle 11, which is provided. Release buttons 12 are provides on both sides of the cradle 11. The safety seat 10 further provides a handle 13, which may be used to carry the safety seat 10 with a child secured within.

The electronic components of the safety seat 10 are battery-powered and may either be constantly active, activated by remote signal by the user, activated by motion sensor, or activated by some other method. Electronic components of the safety seat 10 preferably include a memory device, a microprocessor, an internal ring antenna, a servomotor, a speaker, a transmitter, and a receiver.

To use the first exemplary embodiment, the user may install the safety seat 10 in the user's vehicle, secure a child in the safety seat 10, and use the remote control or the mobile application to recline the safety seat 10.

The safety seat 10 is preferably manufactured from rigid, durable materials, such as steel, aluminum alloy, copper alloy, brass, and plastic, providing a padded upper surface which is preferably manufactured from a flexible, durable material such as foam rubber, covered by a removable and easily laundered upholstered cover which is preferably manufactured from a flexible, durable fabric such as cotton or a cotton-polyester blend. The cradle 11, the release button 12, the handle 13, the memory device, the microprocessor, the internal ring antenna, the servomotor, the speaker, the transmitter, and the receiver are preferably manufactured from rigid, durable materials, such as steel, aluminum alloy, copper alloy, brass, and plastic.

Components, component sizes, and materials listed above are preferable, but artisans will recognize that alternate components and materials could be selected without altering the scope of the invention.

1. A child safety seat system comprising:
a battery-powered electric servomotor which drives an internal gear system that gently and quietly moves the safety seat from an upright position to a reclining position; and
a smartphone device, comprising:
one or more processors; and
a memory device having instructions which, when executed by the one or more processors, cause the smartphone device to:
instantiate a mobile application that is configured to control the child safety seat; and
responsive to receiving user input at the mobile application on the smartphone device, transmit a signal to the child safety seat to recline into the reclining position using the child safety seat's internal gear system.

2. (canceled)

3. The child safety seat of claim 1, wherein the safety seat further provides a pressure switch which detects the presence of a child, and provides an audible alert if the child remains in the safety seat more than 60 seconds after engine of the vehicle stops running.

4. The child safety seat of claim 3, wherein the pressure switch is activated by a predetermined amount of weight.

5. The child safety seat of claim 3, wherein the safety seat is securable in a forward or rear facing position within a cradle.

6. The child safety seat of claim 5, wherein release buttons are provided on both sides of the cradle.

7. The child safety seat of claim 1, wherein the safety seat further provides a handle.

8-12. (canceled)
